(19) United States
(12) Patent Application Publication
(10) Pub. No.: US 2021/0136476 A1
(43) Pub. Date: May 6, 2021

(54) HEADPHONE ADJUSTMENT STRUCTURE

(71) Applicant: AMERICAN FUTURE TECHNOLOGY, City of Industry, CA (US)

(72) Inventor: You-Chi LIU, City of Industry, CA (US)

(21) Appl. No.: 16/996,512

(22) Filed: Aug. 18, 2020

(30) Foreign Application Priority Data
Nov. 6, 2019 (TW) 108140307

(51) Int. Cl. H04R 1/10

(52) U.S. Cl. CPC H04R 1/1008

(57) ABSTRACT

A headphone adjustment structure includes two speaker housings respectively provided with speaker therein for generating sound, two connection bands each having first end thereof connected to one side of one respective speaker housing and an opposing second end thereof extending toward each other, and symmetrical adjustment mechanism including position-limiting sleeve slidably receiving second end of first connection band and second end of second connection band, first gear rack extended from second end of first connection band and slidably set in position-limiting sleeve at one lateral side, second gear rack extended from second end of second connection band and slidably set in position-limiting sleeve at an opposite lateral side and pinion meshed between first and second gear racks. First and second gear racks are meshed with pinion to form left and right equidistant slides to adjust the relative distance of first and second connection bands.

This application claims the priority benefit of Taiwan patent application number 108140307, filed on Nov. 6, 2019.

### BACKGROUND OF THE INVENTION

### 1. Field of the Invention

The present invention relates to headphone technology and more particularly, to a headphone adjustment structure, which provides a symmetrical adjustment mechanism between two connection bands thereof to achieve the purpose of facilitating adjustment and adjusting the structure is stable and not easy to loosen.

### 2. Description of the Related Art

The output devices of audio-visual electronic products include nothing more than headphones/earphones or speakers. In particular, the headphones/earphones have the effect of better exclusive music without interfering with the people around them. At the same times, the headphones/earphones have the characteristics of small size, easy portability and relatively low price. Therefore, headphones/earphones have become a better choice for listening to music. Because the use of headphones/earphones needs to be plugged into the ear canals or cover the outside of the ears, in addition to a good full-range performance, a good pair of headphones/earphones also needs an ergonomic structure with good wearing comfort. The headphones need to be adjusted according to the different head circumference of the user, so that the speaker housings of the built-in speakers can cover the outside of both ears. The headband of the conventional headphones that connects the two speaker housings is mostly a simple metal band structure, so when adjusting the position of the speaker housings, a simple adjustment and expansion structure needs to be designed on the left or right side of the headband to achieve the adjustment. The left and right sides of this conventional headphone design are asymmetrical. In addition to being unsuitable for aesthetics, the appearance of this type of headphones will have difficult feeling for people with visual obsessive-compulsive disorder. From another point of view, the headband structure of thin metal band design is prone to loosening after multiple adjustments by the user, making it impossible to fix or position the position of the two speaker housings. Moreover, when the user adjusts the retractable structure on the left or right side of the headband of the headphones, the volume of the retractable structurer is tool small to be easily adjusted, and it is not easy to directly adjust the positioning by hand operations. This adjustment structure is not simple and intuitive to use. The aforementioned problems need to be improved by those engaged in this industry.

### SUMMARY OF THE INVENTION

The present invention has been accomplished under the circumstances in view. It is a first object of the present invention to provide a headphone adjustment structure, which comprises two speaker housings each being respectively provided with a speaker therein for generating sound, two connection bands each having a first end thereof connected to one side of one respective speaker housing and an opposing second end thereof extending toward each other, and a symmetrical adjustment mechanism set between the two connection bands. The symmetrical adjustment mechanism comprises a position-limiting sleeve slidably receiving the second end of the first connection band and the second end of the second connection band, a first gear rack longitudinally and fixedly extended from the second end of the first connection band and slidably set in the position-limiting sleeve at one lateral side, a second gear rack longitudinally and fixedly extended from the second end of the second connection band and slidably set in the position-limiting sleeve at an opposite lateral side, a pinion disposed in the position-limiting sleeve and meshed between the first gear rack and the second gear rack and provided with a gear axle that is set on a locating plate in a horizontal direction of one of the first connection band and the second connection band. The first gear rack and the second gear racks are meshed with the pinion to form left and right equidistant slides to adjust the relative distance of the first connection band and the second connection band.

It is a first object of the present invention to provide a headphone adjustment structure, which comprises two speaker housings each being respectively provided with a speaker therein for generating sound, two connection bands each having a first end thereof connected to one side of one respective speaker housing and an opposing second end thereof extending toward each other, and a symmetrical adjustment mechanism set between the two connection bands. The symmetrical adjustment mechanism comprises a position-limiting sleeve slidably receiving the second end of the first connection band and the second end of the second connection band, and a retractable crosslink connected between the second end of the first connection band and the second end of the second connection band within the position-limiting sleeve and stretchable to adjust the relative distance of the first connection band and the second connection band.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is a schematic perspective view of a headphone adjustment structure in accordance with a first embodiment of the present invention.

FIG. 2 is a schematic drawing illustrating a stretching action of the symmetrical adjustment mechanism of the headphone adjustment structure in accordance with the first embodiment of the present invention.

FIG. 3 is a schematic drawing illustrating a compression action of the symmetrical adjustment mechanism of the headphone adjustment structure in accordance with the first embodiment of the present invention.

FIG. 4 is a schematic perspective view of a headphone adjustment structure in accordance with a second embodiment of the present invention.

FIG. 5 is a sectional top view of the headphone adjustment structure in accordance with the second embodiment of the present invention.

FIG. 6 is a schematic drawing illustrating a stretching action of the symmetrical adjustment mechanism of the headphone adjustment structure in accordance with the second embodiment of the present invention.

FIG. 7 is a schematic drawing illustrating a compression action of the symmetrical adjustment mechanism of the headphone adjustment structure in accordance with the second embodiment of the present invention.

### DETAILED DESCRIPTION OF THE PREFERRED EMBODIMENT

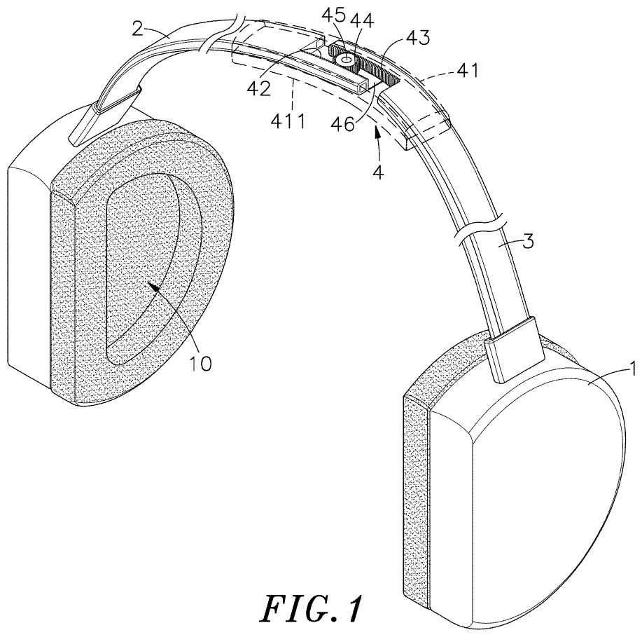

Referring to FIGS. 1-3, a headphone adjustment structure in accordance with a first embodiment of the present invention is set in a pair of headphones, comprising two speaker housings 1, a first connection band 2, a second connection band 3, and a symmetrical adjustment mechanism 4. The more detailed structure and connection relationship of each component are explained as follows:

The two speaker housings 1 are respectively provided with a speaker (not shown) therein for generating sound. Since the structure of the speaker is the same as the conventional art, it will not be repeated here. The inner side of each of the two speaker housings 1 is provided with an approximately semi-circular ear accommodating groove 10.

The two connection bands (including the first connection band 2 and the second connection band 3) each have one end thereof, namely, the fixed end connected to one side of one respective speaker housing 1, and an opposite end thereof, namely, the free end extending toward each other.

The symmetrical adjustment mechanism 4 is set between the first connection band 2 and the second connection band 3, comprising a position-limiting sleeve 41 that slidably receives the free end of the first connection band 2 and the free end of the second connection band 3, a first gear rack 42 longitudinally and fixedly extended from the free end of the first connection band 2 and slidably set in the position-limiting sleeve 41 at one lateral side, a second gear rack 43 longitudinally and fixedly extended from the free end of the second connection band 3 and slidably set in the position-limiting sleeve 41 at an opposite lateral side, a pinion 44 disposed in the position-limiting sleeve 41 and meshed between the first gear rack 42 and the second gear rack 43 and provided with a gear axle 45 that is set on a locating plate 46 in the horizontal direction of one of the first connection band 2 and the second connection band 3. The first and second gear racks 42 and 43 and the pinion 44 are meshed together and form left and right equidistant slides to adjust the relative distance of the first and second connection bands 2 and 3.

The bottom side of the position-limiting sleeve 41 is further provided with a cushion 411. The material of the cushion 411 is composed of sponge and flexible woven cloth, and the cushion 411 of the position-limiting sleeve 41 will bear against the top of the user's head when using the headphones, so that the headphones has a good wearing comfort and an ergonomic structure.

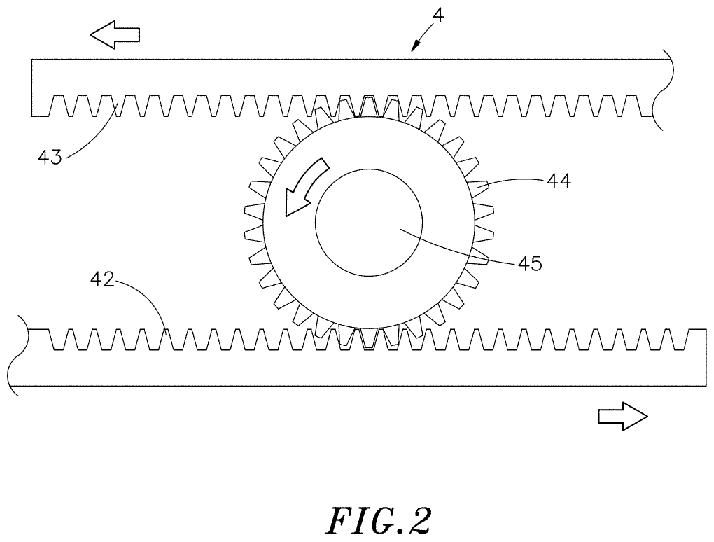

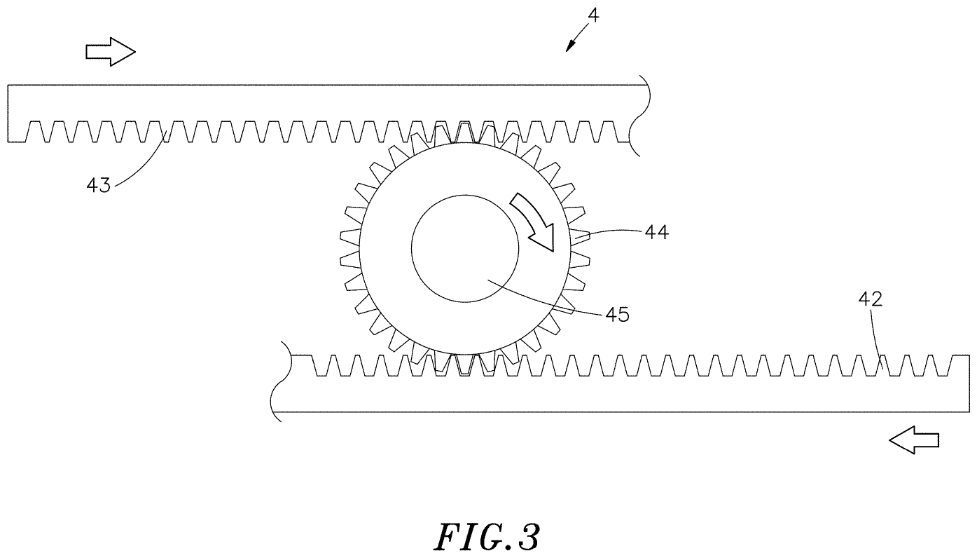

Referring to FIG. 2, when you wish to perform the stretching action on the symmetrical adjustment mechanism 4, the user needs to hold the position-limiting sleeve 41 in one hand and hold the first connection band 2 or second connection band 3 in the other hand to apply downward force, so that the first gear rack 42 extending from the first connection band 2 and the second gear rack 43 extending from the second connection band 3 are displaced towards the relatively outer side with a linkage structure, and the first and second gear racks 42 and 43 meshing with the pinion 44 are moved relative to each other to adjust the relative distance of the first and second connection bands 2 and 3. After the first connection band 2 and second connection band 3 of the headphones are stretched to an approximate length, the user can try on the headphones and then make small adjustments of stretching or compression according to the demand, which can be adjusted to the good wearing position most suitable for the user. Referring to FIG. 3, when you wish to perform the compression action on the symmetrical adjustment mechanism 4, the user needs to hold the position-limiting sleeve 41 in one hand and hold the first connection band 2 or second connection band 3 in the other hand to apply upward force, so that the first gear rack 42 extending from the first connection band 2 and the second gear rack 43 extending from the second connection band 3 are displaced towards the relatively inner side with a linkage structure, and the first and second gear racks 42 and 43 meshing with the pinion 44 are moved relative to each other to adjust the relative distance of the first and second connection bands 2 and 3. After the first connection band 2 and second connection band 3 of the headphones are compressed to an approximate length, the user can try on the headphones and then make small adjustments of stretching or compression according to the demand, which can be adjusted to the good wearing position most suitable for the user. Or, the user can hold the position-limiting sleeve 41 in one hand and hold the first connection band 2 or the second connection band 3 in the other hand to apply upward force to the dead point. At this time, the combined length of the first connection band 2 and the second connection band 3 exposed to the position-limiting sleeve 41 is the shortest, which is convenient for the storage of the headphones.

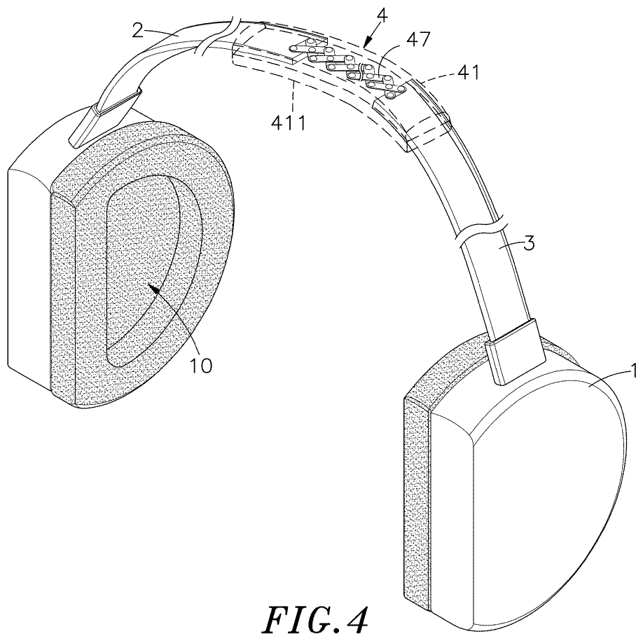

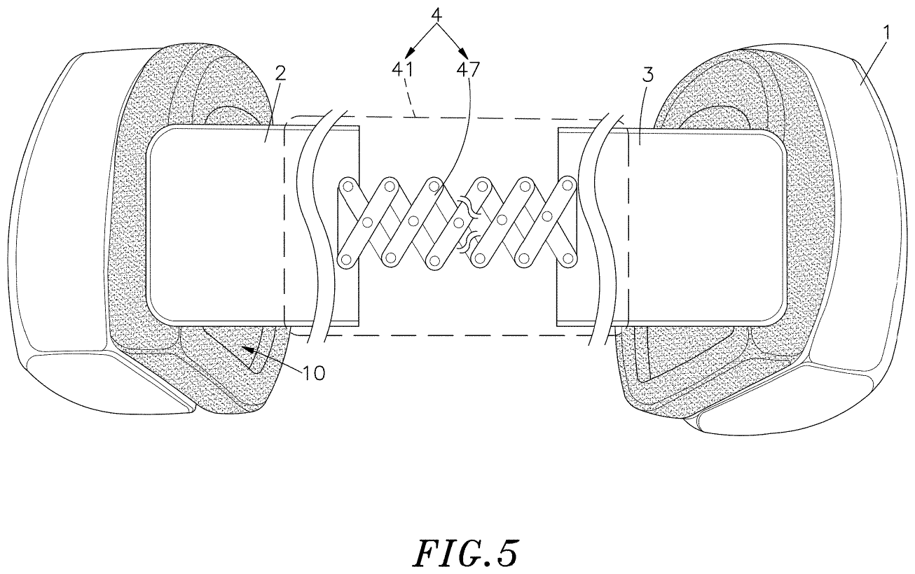

Referring to FIGS. 4-7, a headphone adjustment structure in accordance with a second embodiment of the present invention is set in a pair of headphones, comprising two speaker housings 1, a first connection band 2, a second connection band 3, and a symmetrical adjustment mechanism 4. The more detailed structure and connection relationship of each component are explained as follows:

The two speaker housings 1 are respectively provided with a speaker (not shown) therein for generating sound. Since the structure of the speaker is the same as the conventional art, it will not be repeated here. Each of the inner sides of the two speaker housings 1 is provided with an approximately semi-circular ear accommodating groove 10.

The two connection bands (including the first connection band 2 and the second connection band 3) each have one end thereof, namely, the fixed end connected to one side of one respective speaker housing 1, and an opposite end thereof, namely, the free end extending toward each other.

The symmetrical adjustment mechanism 4 is set between the first connection band 2 and the second connection band 3, comprising a position-limiting sleeve 41 that slidably receives the free end of the first connection band 2 and the free end of the second connection band 3, and a retractable crosslink 47 connected between the free end of the first connection band 2 and the free end of the second connection band 3 inside the position-limiting sleeve 41. Adjust the expansion and contraction of the crosslink 47 to form the left and right equidistant adjustment of the relative distance of the two connection bands 2 and 3.

The bottom side of the position-limiting sleeve 41 is further provided with a cushion 411. The material of the cushion 411 is composed of sponge and flexible woven cloth, and the cushion 411 of the position-limiting sleeve 41 will bear against the top of the user's head when using the headphones, so that the headphones has a good wearing comfort and an ergonomic structure.

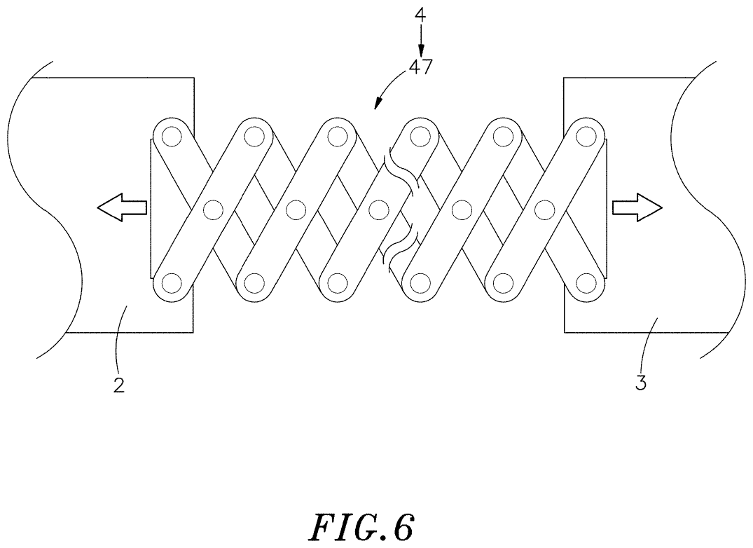

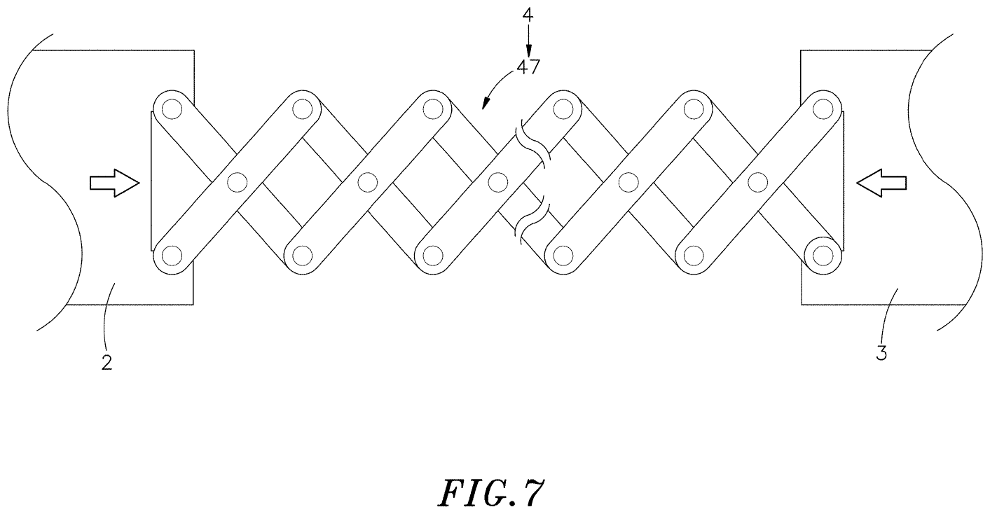

Referring to FIG. 6, when you wish to perform the stretching action on the symmetrical adjustment mechanism 4, the user needs to hold the position-limiting sleeve 41 in one hand and hold the first connection band 2 or second connection band 3 in the other hand to apply downward force, so that the width of the crosslink 47 between the first connection band 2 and the second connection band 3 is narrowed and the length of the crosslink 47 is increased, and the relative distance of the first and second connection bands 2 and 3 is adjusted. After the first connection band 2 and second connection band 3 of the headphones are stretched to an approximate length, the user can try on the headphones and then make small adjustments of stretching or compression according to the demand, which can be adjusted to the good wearing position most suitable for the user. Referring to FIG. 7, when you wish to perform the compression action on the symmetrical adjustment mechanism 4, the user needs to hold the position-limiting sleeve 41 in one hand and hold the first connection band 2 or the second connection band 3 in the other hand to apply upward force. This makes the width of the crosslink 47 between the first connection band 2 and the second connection band 3 wider to shorten the length of the crosslink 47, and thus, the relative distance of the first and second connection bands 2 and 3 is adjusted. After the first connection band 2 and the second connection band 3 of the headphones are compressed to an approximate length, the user can try on the headphones and then make small adjustments of stretching or compression according to the demand, which can be adjusted to the good wearing position most suitable for the user. Or, the user can hold the position-limiting sleeve 41 in one hand and hold the first connection band 2 or the second connection band 3 in the other hand to apply upward force to the dead point. At this time, the combined length of the first connection band 2 and the second connection band 3 exposed to the position-limiting sleeve 41 is the shortest, which is convenient for the storage of the headphones.

It can be known from the above proposed content that the present invention is a headphone adjustment structure, which comprises two speaker housings, two connection bands and a symmetrical adjustment mechanism. The two speaker housings each are respectively provided with a speaker therein for generating sound. The two connection bands each have a first end thereof connected to one side of one respective speaker housing and an opposing second end thereof extending toward each other. The symmetrical adjustment mechanism is set between the two connection bands. The symmetrical adjustment mechanism comprises a position-limiting sleeve slidably receiving the second ends of the two second connection bands, two racks respectively and fixedly extended from the second ends of the two connection bands and slidably set in the position-limiting sleeve at two opposite lateral sides, and a pinion meshed between the two gear racks and provided with a gear axle that is set on a locating plate in a horizontal direction of one of the two connection bands, The two gear racks are meshed with the pinion to form left and right equidistant slides to adjust the relative distance of the two connection bands. With the aforementioned headphone adjustment structure with a symmetrical adjustment mechanism between the two connection bands, the headphone adjustment structure is stable, not easy to loosen and each to adjust. It has an excellent selling point in the high-end headphone market, so it filed a patent application to seek the protection of patent rights.

What the invention claimed is:

1. A headphone adjustment structure used in a pair of headphones, comprising:
two speaker housings each being respectively provided with a speaker therein for generating sound;
two connection bands each having a first end thereof connected to one side of one respective said speaker housing and an opposing second end thereof extending toward each other; and
a symmetrical adjustment mechanism set between said two connection bands, said symmetrical adjustment mechanism comprising a position-limiting sleeve slidably receiving the second ends of said two connection bands, two gear racks respectively and fixedly extended from the second ends of said two connection bands and slidably set in said position-limiting sleeve at two opposite lateral sides and a pinion meshed between said two gear racks within said position-limiting sleeve and provided with a gear axle that is set on a locating plate in a horizontal direction of one of said two connection bands, said two gear racks being meshed with said pinion to form left and right equidistant slides to adjust the relative distance of said first connection band and said second connection band.

2. The headphone adjustment structure as claimed in claim 1, wherein said position-limiting sleeve has a bottom side thereof provided with a cushion, the material of said cushion being composed of sponge and flexible woven cloth.

3. The headphone adjustment structure as claimed in claim 1, wherein each said speaker housing has an inner side thereof provided with an approximately semi-circular ear accommodating groove.

4. A headphone adjustment structure used in a pair of headphones, comprising:
two speaker housings each being respectively provided with a speaker therein for generating sound;
two connection bands each having a first end thereof connected to one side of one respective said speaker housing and an opposing second end thereof extending toward each other; and
a symmetrical adjustment mechanism set between said two connection bands, said symmetrical adjustment mechanism comprising a position-limiting sleeve slidably receiving the second ends of said two connection bands and a retractable crosslink connected between the second ends of said two connection bands within said position-limiting sleeve and stretchable to adjust the relative distance of said two connection bands.

5. The headphone adjustment structure as claimed in claim 4, wherein said position-limiting sleeve has a bottom side thereof provided with a cushion, the material of said cushion being composed of sponge and flexible woven cloth.

6. The headphone adjustment structure as claimed in claim 4, wherein each said speaker housing has an inner side thereof provided with an approximately semi-circular ear accommodating groove.
